(19) United States
(12) Patent Application Publication
(10) Pub. No.: US 2010/0084023 A1
(43) Pub. Date: Apr. 8, 2010

(54) FLOW CONTROL MODULE FOR A FLUID DELIVERY SYSTEM

(76) Inventors: Chris Melcer, Aptos, CA (US); Thuy Britcher, San Jose, CA (US); Avi Tepman, Cupertino, CA (US); Simon Y. Yavelberg, Cupertino, CA (US); Sheshraj L. Tulshibagwale, Santa Clara, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/247,013

(22) Filed: Oct. 7, 2008

(51) Int. Cl. F16K 11/00

(52) U.S. Cl. 137/14; 137/861

(57) ABSTRACT

Embodiments described herein provide an application for delivery of fluids within substrate processing systems. More particularly, embodiments described herein provide applications for delivery of processing chemicals within substrate processing systems. In one embodiment, a fluid delivery system is provided. The fluid delivery system comprises a bulk fluid source for supplying fluids, a fluid delivery module for controlling and monitoring a ratio of fluids flowing from the bulk fluid source, a first stream line positioned downstream from the fluid delivery module, a first switch positioned along the first stream line, a second stream line positioned downstream from the fluid delivery module, and a second switch positioned along the second stream line, wherein the fluid delivery module splits the fluids from the bulk fluid source into two streams flowing through the first stream line and the second stream line according to a pre-defined ratio.

### BACKGROUND OF THE INVENTION

1. Field of the Invention

Embodiments described herein relate to semiconductor processing, and more particularly to an apparatus for fluid delivery within substrate processing systems.

2. Description of the Related Art

A chip manufacturing facility is composed of a broad spectrum of technologies. Cassettes containing semiconductor substrates are routed to various stations in the facility where they are either processed or inspected. Semiconductor processing involves the deposition of material onto and removal of material from substrates. Typical processes include chemical vapor deposition (CVD), physical vapor deposition (PVD), electrochemical plating (ECP), chemical mechanical planarization (CMP), etching, cleaning, and others. Of the above processes, approximately 25% involve liquid chemical processes.

One issue regarding semiconductor processing involves the accurate delivery of fluids to tightly control the chemical concentrations within a process solution. Conventional fluid delivery systems take fluids, such as processing chemicals, from bulk supplies, local reservoirs, or bottles and deliver them using a metering pump and/or flow meter. A typical system uses a fixed orifice with constant pressure. More specifically, such a system may control flow with an orifice, for example a control valve, and a pressure regulator, for example a flow meter, which maintains a constant fluid pressure upstream of the control valve and therefore maintains a constant flow rate.

There are various flow meter technologies available to measure the amount of fluid dispensed, and one of the frequently used technologies is differential pressure technology. Differential pressure technology incorporates measurement of pressure by placing a flow meter on the outlet side of an orifice to measure the flow rate of the fluid. However, flow meters are prone to particle generation and require periodic service and calibration. In addition, conventional flow meter technologies are unable to provide accurate measurement for small volumes or very low flow rates. The technologies capable of more accurate mass flow measurement tend to be more expensive.

Also, it is also sometimes desirable that two different chemicals be selectively mixed and/or delivered to respective sides of a wafer. However, conventional flow meter technologies are only capable of measuring the flow rate of a single fluid. Conventional flow meter technologies are unable to control or monitor the division of a fluid into two or more fluid streams.

Therefore, there is a need for a fluid delivery system configured to provide controllable fluid delivery, improved fluid delivery precision, and increased fluid utilization into multiple streams.

### SUMMARY OF THE INVENTION

Embodiments described herein provide an application for delivery of fluids within substrate processing systems. More particularly, embodiments described herein provide applications for delivery of processing chemicals within substrate processing systems. In one embodiment, a fluid delivery system is provided. The fluid delivery system comprises a bulk fluid source for supplying fluids, a fluid delivery module for controlling and monitoring a ratio of fluids flowing from the bulk fluid source, a first stream line positioned downstream from the fluid delivery module, a first switch positioned along the first stream line, a second stream line positioned downstream from the fluid delivery module, and a second switch positioned along the second stream line, wherein the fluid delivery module splits the fluids from the bulk fluid source into two streams flowing through the first stream line and the second stream line according to a pre-defined ratio.

In another embodiment, a fluid delivery system is provided. The fluid delivery system comprises a control valve for controlling the flow of the fluids from the bulk fluid source, a flow meter positioned upstream from the control valve, a first pressure transducer positioned upstream from the flow meter, a second pressure transducer positioned in between the flow meter and the control valve, and a switch positioned downstream from the control valve, a first stream line coupled with the switch, and a second stream line coupled with the switch, wherein the first stream line and the second stream line are positioned downstream from the switch.

In yet another embodiment, a system for chemical mechanical polishing of substrate is provided. The system comprises a platen assembly, a polishing surface supported on the platen assembly, one or more polishing heads on which substrates are retained while polishing, and a fluid delivery system for delivering fluids to the polishing surface. The fluid delivery system comprises a bulk fluid source for supplying fluids, a fluid delivery module for controlling and monitoring a ratio of fluids flowing from the bulk fluid source, a first stream line positioned downstream from the fluid delivery module, a first switch positioned along the first stream line, a second stream line positioned downstream from the fluid delivery module, and a second switch positioned along the second stream line, wherein the fluid delivery module splits the fluids from the bulk fluid source into two streams flowing through the first stream line and the second stream line according to a pre-defined ratio.

In yet another embodiment, a method for controlling the flow of a fluid through a fluid delivery system is provided. The method comprises flowing a fluid through a fluid delivery system comprising a bulk fluid source for supplying fluids, a fluid delivery module for controlling and monitoring a ratio of fluids flowing from the bulk fluid source, a first stream line positioned downstream from the fluid delivery module, a first switch positioned along the first stream line, a second stream line positioned downstream from the fluid delivery module, and a second switch positioned along the second stream line, wherein the fluid delivery module splits the fluids from the bulk fluid source into two streams flowing through the first stream line and the second stream line according to a pre-defined ratio, measuring a differential pressure for each of the first stream line and the second stream line by shutting off each of the first switch and the second switch intermittently, and determining the ratio of the flows when both stream lines are open by comparing the differential pressure measurements from the first stream line and the second stream line.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of the invention and are therefore not to be considered limiting of its scope, for the invention may admit to other equally effective embodiments.

FIG. 1 is a top plan view of one embodiment of a chemical mechanical polishing system;

FIG. 2A is a schematic drawing of a fluid delivery system according to one embodiment described herein;

FIG. 2B is a schematic drawing of a fluid delivery system according to another embodiment described herein;

FIG. 3A is a schematic drawing of a fluid delivery system according to another embodiment described herein;

FIG. 3B is a schematic drawing of a fluid delivery system according to another embodiment described herein; and

FIG. 4 is a schematic drawing of a fluid delivery system according to another embodiment described herein.

### DETAILED DESCRIPTION

Embodiments described herein relate to semiconductor processing, and more particularly to an apparatus for fluid delivery within substrate processing systems. Flow controllers are usually the most expensive component in fluid delivery systems and represent the largest percentage of material cost of any type of component. Embodiments described herein advantageously provide a means for controlling and/or monitoring the division of a fluid stream into two or more streams of equal amounts or predefined ratios without the need for additional costly flow controllers. In one embodiment, a control valve is positioned upstream of a flow measurement device and/or additional pressure transducer(s) are positioned on the downstream side of the control valve so that the back pressure associated with dispense tubing between the flow controller and the point of dispense may be measured.

While the particular apparatus in which the embodiments described herein can be practiced is not limited, it is particularly beneficial to practice the embodiments in a REFLEXION® LK CMP system and MIRRA MESA® system sold by Applied Materials, Inc., Santa Clara, Calif. Additionally, CMP systems available from other manufacturers may also benefit from embodiments described herein. Embodiments described herein may also be practiced on overhead circular track polishing systems.

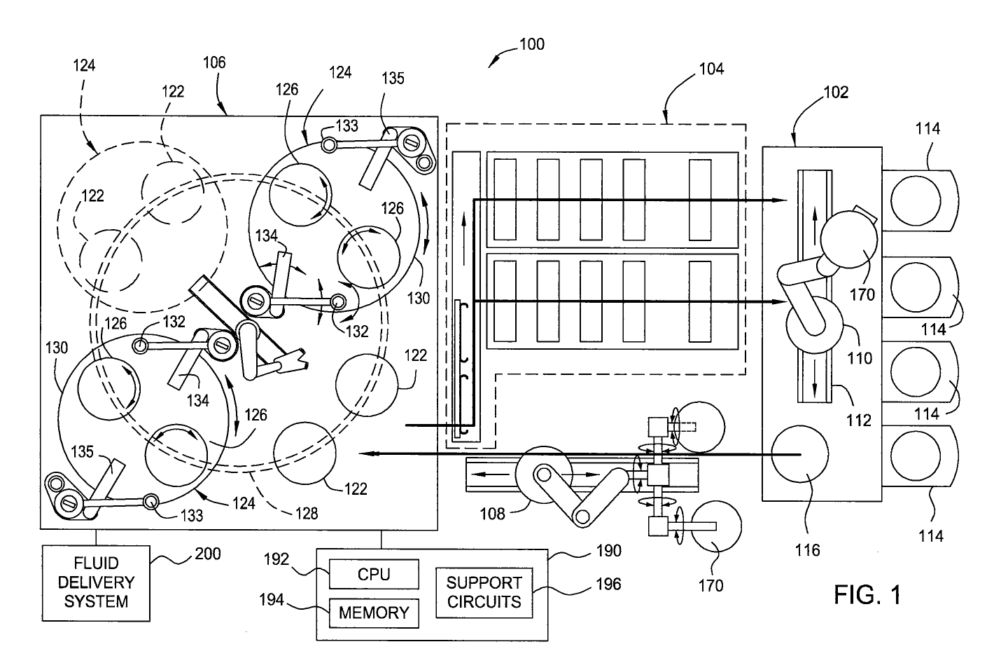

FIG. 1 is a top plan view illustrating one embodiment of a chemical mechanical polishing (“CMP”) system 100 comprising a fluid delivery system 200 according to embodiments described herein. The CMP system 100 includes a factory interface 102, a cleaner 104 and a polishing module 106. A wet robot 108 is provided to transfer substrates 170 between the factory interface 102 and the polishing module 106. The wet robot 108 may also be configured to transfer substrates between the polishing module 106 and the cleaner 104. The factory interface 102 includes a dry robot 110 which is configured to transfer substrates 170 between one or more cassettes 114 and one or more transfer platforms 116. In one embodiment depicted in FIG. 1, four substrate storage cassettes 114 are shown. The dry robot 110 has sufficient range of motion to facilitate transfer between the four cassettes 114 and the one or more transfer platforms 116. Optionally, the dry robot 110 may be mounted on a rail or track 112 to position the robot 110 laterally within the factory interface 102, thereby increasing the range of motion of the dry robot 110 without requiring large or complex robot linkages. The dry robot 110 additionally is configured to receive substrates from the cleaner 104 and return the clean polished substrates to the substrate storage cassettes 114. Although one substrate transfer platform 116 is shown in the embodiment depicted in FIG. 1, two or more substrate transfer platforms may be provided so that at least two substrates may be queued for transfer to the polishing module 106 by the wet robot 108 at the same time.

Still referring to FIG. 1, the polishing module 106 includes a plurality of polishing stations 124 on which substrates are polished while retained in one or more polishing heads 126. The polishing stations 124 are sized to interface with two or more polishing heads 126 simultaneously so that polishing of two or more substrates may occur using a single polishing station 124 at the same time. The polishing heads 126 are coupled to a carriage (not shown) that is mounted to an overhead track 128 that is shown in phantom in FIG. 1. The overhead track 128 allows the carriage to be selectively positioned around the polishing module 106 which facilitates positioning of the polishing heads 126 selectively over the polishing stations 124 and load cup 122. In the embodiment depicted in FIG. 1, the overhead track 128 has a circular configuration which allows the carriages retaining the polishing heads 126 to be selectively and independently rotated over and/or clear of the load cups 122 and the polishing stations 124. The overhead track 128 may have other configurations including elliptical, oval, linear, or other suitable orientations and the movement of the polishing heads 126 may be facilitated using other suitable devices.

In one embodiment depicted in FIG. 1, two polishing stations 124 are shown located in opposite corners of the polishing module 106. At least one load cup 122 is in the corner of the polishing module 106 between the polishing stations 124 closest the wet robot 108. The load cup 122 facilitates transfer between the wet robot 108 and the polishing head 126. Optionally, a third polishing station 124 (shown in phantom) may be positioned in the corner of the polishing module 126 opposite the load cups 122. Alternatively, a second pair of load cups 122 (also shown in phantom) may be located in the corner of the polishing module 106 opposite the load cups 122 that are positioned proximate the wet robot. Additional polishing stations 124 may be integrated in the polishing module 106 in systems having a larger footprint.

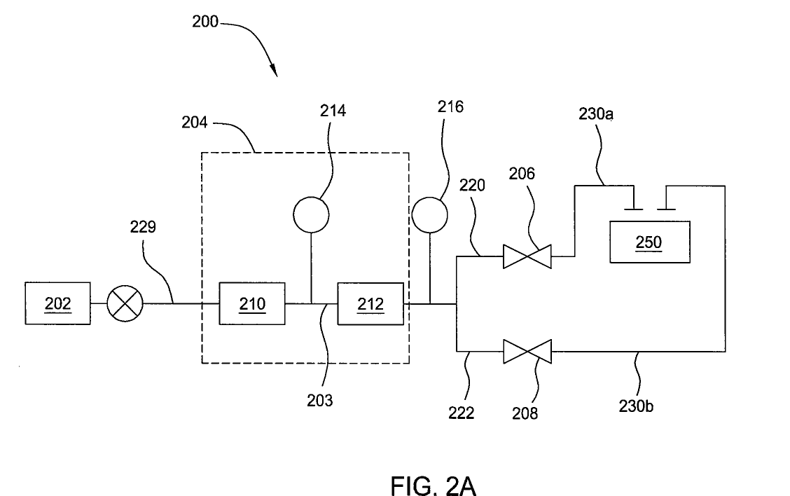

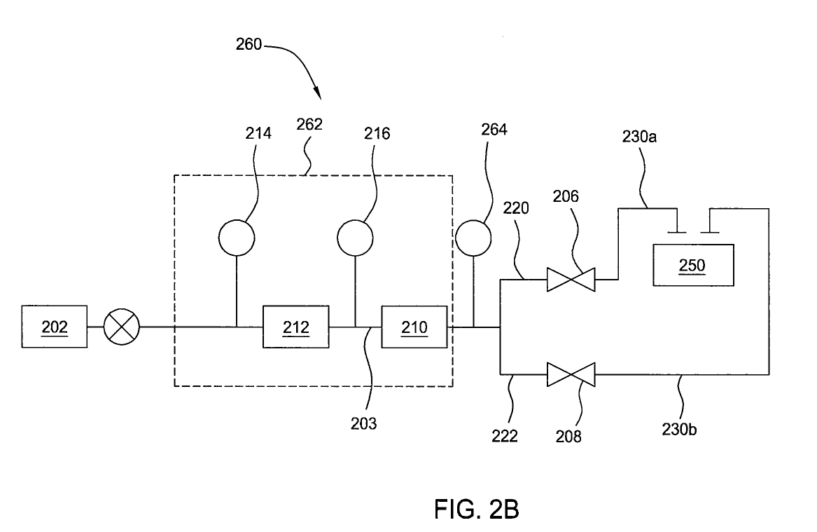

Each polishing station 124 includes a polishing surface 130 capable of polishing at least two substrates at the same time and a matching number of polishing units for each of the substrates. Each of the polishing units includes a polishing head 126, a pad conditioning assembly 132 which dresses the pad by removing polishing debris and opening the pores of the pad, and a polishing fluid delivery arm 134. In one embodiment, each polishing station 124 comprises multiple pad conditioning assemblies 132, 133. In one embodiment, each polishing station 124 comprises multiple fluid delivery arms 134, 135 for the delivery of a fluid stream to each polishing stations 124. The polishing surface 130 is supported on a platen assembly 250 (see FIG. 2) which rotates the polishing surface 130 during processing. In one embodiment, the polishing surface 130 is suitable for at least one of a chemical mechanical polishing and/or an electrochemical mechanical polishing process. In another embodiment, the platen assembly 250 may be rotated during polishing at a rate from about 10 rpm to about 150 rpm, for example, about 50 rpm to about 110 rpm, such as about 80 rpm to about 100 rpm.

To facilitate control of the CMP system 100 and processes performed thereon, a controller 190 comprising a central processing unit (CPU) 192, memory 194, and support circuits 196, is connected to the CMP system 100. The CPU 192 may be one of any form of computer processor that can be used in an industrial setting for controlling various drives and pressures. The memory 194 is connected to the CPU 192. The memory 194, or computer-readable medium, may be one or more of readily available memory such as random access memory (RAM), read only memory (ROM), floppy disk, hard disk, or any other form of digital storage, local or remote. The support circuits 196 are connected to the CPU 192 for supporting the processor in a conventional manner. These circuits include cache, power supplies, clock circuits, input/output circuitry, subsystems, and the like.

FIG. 2A is a schematic drawing of a fluid delivery system 200 according to one embodiment described herein. The fluid delivery system 200 comprises a bulk fluid source 202 for supplying a process chemical or chemicals to the polishing system 100, a fluid delivery module 204 for controlling and monitoring the flow rate of the fluid streams flowing from the bulk fluid source 202 through the stream line 203, and first and second switches 206 and 208 which may be multi input/output valves that regulate the flow of fluid to the platen assembly 250 of each polishing station 124 for substrate processing. In one embodiment, during or following fluid delivery, the first and second switches 206 and 208 may direct a fluid stream via tubing 230a and 230b for a fluid dispense process. The tubing 230a and 230b may be formed of flexible materials such as polytetrafluoroethylene (PTFE), vinyl, and other plastic materials that are chemically compatible with process chemistries. The tubing 230a and 230b may be configured in any diameter, flexibility, and wall thickness.

The fluid delivery module 204 is further adapted to measure the amount of fluid delivered from the bulk fluid source 202, split the fluid into two streams flowing through a first stream line 220 and a second stream line 222, according to a pre-defined ratio, and deliver the fluid in a metered amount through the first switch 206 positioned along the first stream line 220 and the second switch 208 positioned along the second stream line 222 to the platen assembly 250. The fluid delivery module 204 may include a control valve 210 for controlling the flow of fluids from the bulk fluid source 202 via tubing 229. The tubing 229 may be formed of flexible materials such as PTFE, vinyl, and other plastic materials that are chemically compatible with the fluids. The tubing 229 may be configured in any diameter, flexibility, and wall thickness. The fluid delivery module 204 may further include a flow meter 212 for monitoring the flow rate of the fluid flowing through the stream line 203. The flow meter 212 communicates with the control valve 210 via a feedback loop (not shown).

The fluid delivery module 204 may further include pressure detection devices, for example, a first pressure transducer 214 and a second pressure transducer 216. The pressure transducers 214 and 216 may be used to determine a degree of resistance or impedance of the fluid within the stream line 203 at a certain point. The impedance may be determined by measuring and calculating the differential pressure at various locations within the stream line 203. By measuring the differential pressure of the fluid in the stream line 203, a ratio of the fluid flowing in the first stream line 220 and the second stream line 222 is determined, and the consistency of the ratio can be monitored in real-time.

In one embodiment, the control valve 210 is positioned upstream from the flow meter 212, the first pressure transducer 214 is positioned in between the control valve 210 and the flow meter 212 to monitor the pressure of the fluid flowing through stream line 203, and the second pressure transducer 216 is positioned downstream from the flow meter 212. A first measurement of the impedance may be taken by the first pressure transducer 214 before the fluid flows through the flow meter 212.

In one embodiment, the second pressure transducer 216 is positioned downstream of the flow meter 212. The second pressure transducer 216 may also measure impedance which can be used to determine the ratio between the two fluid streams. In one embodiment, the ratio of the two fluid streams may be equal or the ratio may be any combination of pre-defined ratios based on processing requirements. By using a pre-defined ratio for the fluid streams, the controller 190 is able to control and monitor the two fluid streams according to the pre-defined ratio. The impedance measured by the pressure transducers 214 and 216 may also be used to determine the differential pressure across the stream line 203 and the flow rate of the fluid. Also, by placing the second pressure transducer 216 downstream from the flow meter 212, the second pressure transducer 216 may provide additional pressure data that acts as a second measure in the differential pressure determination and the measure of impedance.

In operation, a differential pressure measurement may be made for each of the first stream line 220 and the second stream line 222 by shutting off each of the first switch 206 and the second switch 208 individually. For example, the first switch 206 may be closed while the second switch 208 remains open and the differential pressure for the second stream line 222 is measured. The ratio of the individual differential pressure measurements from the first stream line 220 and the second stream line 222 is the ratio of the flows when both/all stream lines are open. This ratio measurement may be used periodically to monitor the consistency of the ratio of the flows through the stream lines and detect any divergence from requirements in real-time, due to, for example, clogging of the stream lines by polishing slurry.

FIG. 2B is a schematic drawing of a fluid delivery system 260 according to another embodiment described herein. The impedance and the differential pressure of the fluid being delivered may be measured in a different configuration of a fluid delivery system 260. Some of the components in the fluid delivery system 260 are also present in the fluid delivery system 200 as discussed in FIG. 2A. In one embodiment, the fluid delivery system 260 includes a bulk fluid source 202, a fluid delivery module 262, which also controls and monitors the fluid streams flowing from the bulk fluid source 202 through the stream line 203, and first and second switches 206 and 208. In the fluid delivery module 262, the flow meter 212 is positioned upstream from the control valve 210. A first pressure transducer 214 is positioned upstream from the flow meter 212. A second pressure transducer 216 is positioned in between the flow meter 212 and the control valve 210. A third pressure transducer 264 is positioned downstream from the control valve 210. In one embodiment, the fluid flows from the bulk fluid source 202 past the first pressure transducer 214 where a first impedance may be measured by the first pressure transducer 214. After the fluid flows through the flow meter 212, a second impedance may be measured by the second pressure transducer 216 before the fluid reaches the control valve 210. The first impedance measurement and the second impedance measurement may be compared to determine if a pre-defined ratio was achieved. If the pre-defined ratio was not achieved, in-situ real-time adjustments may be made to adjust the pressure within the stream line to achieve the pre-defined ratio. If the pre-defined ratio was reached, a third impedance measurement may then be measured by the third pressure transducer 264 to evaluate the consistency of the ratio through out the stream line. It is important that a pressure transducer be positioned downstream from the control valve 210 or the flow meter 212 to take a second measurement of the pressure and determine if the ratio measured from the pressure transducer matches the ratio measured from the previous pressure transducer and that the consistency of the ratio are maintained throughout.

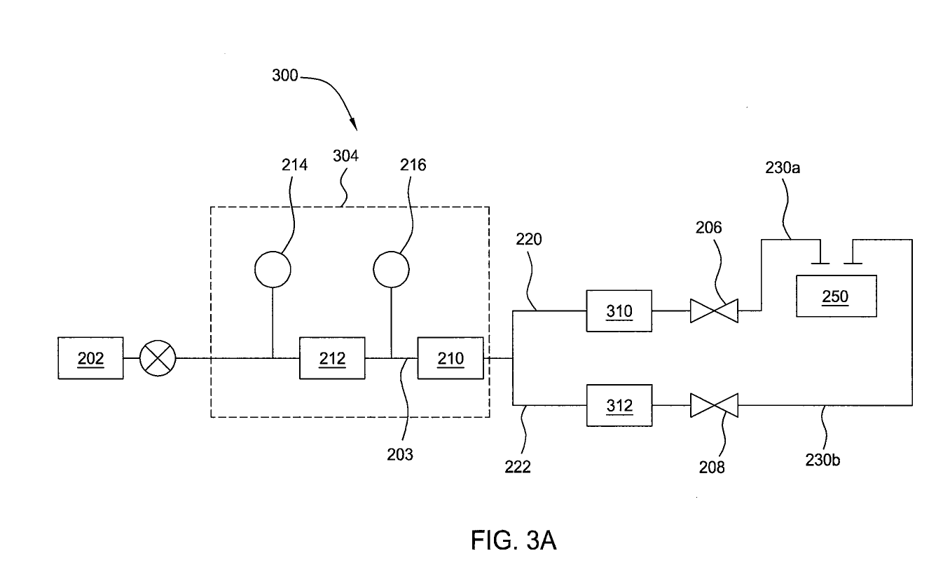

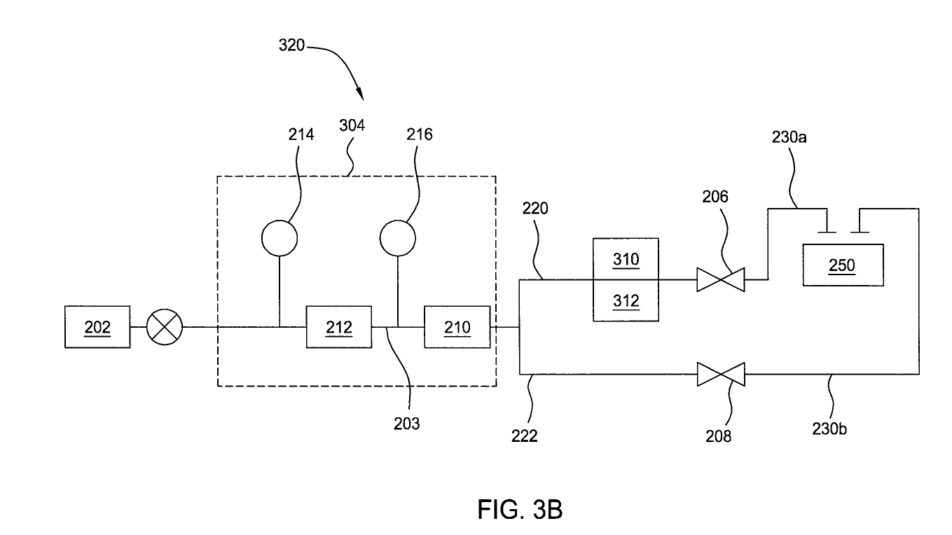

FIG. 3A is a schematic drawing of a fluid delivery system 300 according to another embodiment described herein. The alternative embodiment of the fluid delivery system 300 is similar to the fluid delivery system 260 in FIG. 2B. In one embodiment, the fluid delivery system 300 includes a bulk fluid source 202, a fluid delivery module 304, which also controls and monitors the fluid streams flowing from the bulk fluid source 202 through out the stream line 203, and the first and second switches 206 and 208. In the fluid delivery module 304, the flow meter 212 is positioned upstream from the control valve 210. A first pressure transducer 214 is positioned upstream from the flow meter 212. A second pressure transducer 216 is positioned in between the flow meter 212 and the control valve 210. The fluid flowing through the fluid delivery module 204 may be split into two streams flowing through a first stream line 220 and a second stream line 222, according to a pre-defined ratio. On the first stream line 220, a second control valve 210 is positioned upstream from the first switch 206, and on the second stream line 222, a second flow meter 212 is positioned upstream from the second switch 208. This configuration may be used to control and monitor one of the two streams without affecting the total flow of the fluid through the stream line. After the fluid has passed through the fluid delivery module 304 and is split into two streams flowing through the first stream line 220 and the second stream line 222, the stream flowing through the first stream line 220 going to the second control valve 310 will proceed with a flow rate as pre-defined by the fluid delivery module 304. The flow rate of the stream flowing through the second stream line 222 going to the second flow meter 312 may then be monitored.

FIG. 3B is a schematic drawing of a fluid delivery system 320 according to another embodiment described herein. The system 320 in FIG. 3B is similar to the fluid delivery system 300 in FIG. 3A. In one embodiment, the fluid delivery system 320 includes a bulk fluid source 202, a fluid delivery module 304, which also controls and monitors the fluid streams flowing from the bulk fluid source 202 through out the stream line 203, and the first and second switches 206 and 208. The difference between the fluid delivery system 320 and the fluid delivery system 300 is the position of the second control valve 310 and the second flow meter 312. In this configuration, the second control valve 310 and the second flow meter 312 are positioned upstream from only one of the first and second switches 206 or 208. Fluid flowing through the first stream line 222 going to the second switch 208 without either the second control valve 310 or the second flow meter 312 will proceed with a flow rate as pre-determined by the fluid delivery module 304. Fluid flowing through the first stream line 220 going to the first switch 206 with both the second control valve 310 and the second flow meter 312 will be controlled and monitored. The flow rate of fluid flowing through the first stream line 220 going to the first switch 206 may be controlled and monitored to match the flow rate of fluid flowing through the second stream line 222 going to the second switch 208 without affecting the total flow of the fluid.

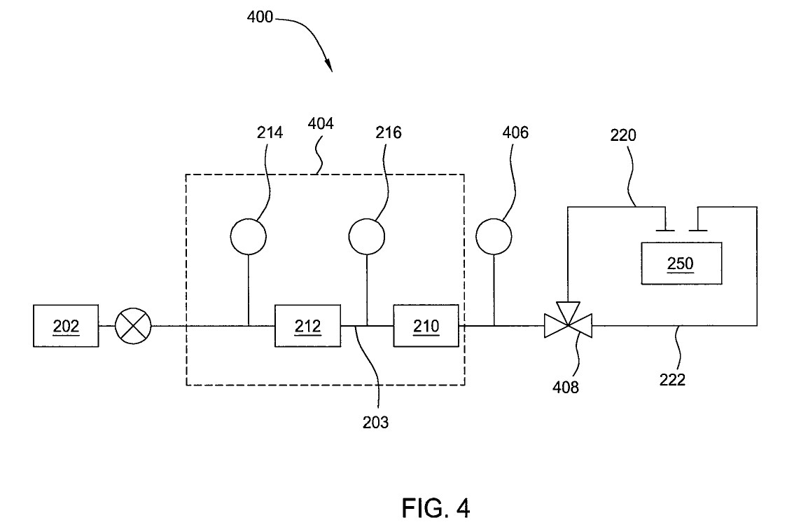

FIG. 4 is a schematic drawing of a fluid delivery system 400 according to another embodiment described herein. In one embodiment, the fluid delivery system 400 includes a bulk fluid source 202, a fluid delivery module 404, which also controls and monitors the fluid streams coming through the bulk fluid source 202 through out the stream line 203, and a switch 408. In the fluid delivery module 404, the flow meter 212 is positioned upstream from the control valve 210. A first pressure transducer 214 is positioned upstream from the flow meter 212. A second pressure transducer 216 is positioned in between the flow meter 212 and the control valve 210. Optionally, a third pressure transducer 406 may be positioned before the switch 408. The switch 408 may comprise a three-way switch or two two-way switches.

The fluid delivery module 404 may split the fluids flowing through the stream line 203 into two streams flowing through a first stream line 220 and a second stream line 222, in which the flow meter 212 may monitor the stream lines intermittently to ensure constant flow throughout the system. It is important for the first pressure transducer 214, the second pressure transducer 216, and the third pressure transducer 406 to accurately measure the impedance and the differential pressure within the stream line while fluids are flowing through. Accurate measurement enables the control valve 210 to control and maintain the same ratio between multiple streams while keeping the total flow of the fluid constant throughout the stream line so that the fluid may be evenly distributed to the platen 250 during substrate processing.

While the foregoing is directed to embodiments of the invention, other and further embodiments of the invention may be devised without departing from the basic scope thereof, and the scope thereof is determined by the claims that follow.

1. A fluid delivery system, comprising:
a bulk fluid source for supplying fluids;
a fluid delivery module for controlling and monitoring a ratio of fluid flowing from the bulk fluid source;
a first stream line positioned downstream from the fluid delivery module;
a first switch positioned along the first stream line;
a second stream line positioned downstream from the fluid delivery module; and
a second switch positioned along the second stream line, wherein the fluid delivery module splits the fluid from the bulk fluid source into two streams flowing through the first stream line and the second stream line according to a pre-defined ratio.

2. The fluid delivery system of claim 1, wherein the fluid delivery module comprises:
a control valve for controlling the flow of the fluids from the bulk fluid source;
a flow meter for monitoring the flow rate of the fluids flowing from the bulk fluid source; and
a first pressure transducer for monitoring the pressure of fluids flowing through the fluid delivery module.

3. The fluid delivery system of claim 1, wherein the fluid delivery module comprises:
a flow meter for monitoring the flow rate of the fluids flowing from the bulk fluid source;
a control valve positioned upstream from the flow meter;
a first pressure transducer positioned in between the control valve and the flow meter; and
a second pressure transducer positioned downstream from the flow meter.

4. The fluid delivery system of claim 1, wherein the fluid delivery module comprises:
a control valve for controlling the flow of the fluids from the bulk fluid source;
a flow meter positioned upstream from the control valve;
a first pressure transducer positioned upstream from the flow meter; and
a second pressure transducer positioned in between the flow meter and the control valve.

5. The fluid delivery system of claim 4, wherein the first and second pressure transducers are configured for measuring impedance of the fluid for determining the ratio of the fluid flowing in the first stream line and the second stream line.

6. The fluid delivery system of claim 4, wherein the fluid delivery module further comprises a third pressure transducer positioned downstream from the control valve.

7. The fluid delivery system of claim 1, wherein the ratio of the fluids can be adjusted to a pre-defined ratio by taking a first measurement of the impedance and comparing the first measurement of the impedance with a second measurement of the impedance.

8. The fluid delivery system of claim 4, further comprising:
a second control valve positioned along the first stream line and upstream from the first switch; and
a second flow meter positioned along the second stream line and upstream from the second switch.

9. The fluid delivery system of claim 4, further comprising:
a second control valve positioned along the first stream line and upstream from the first switch; and
a second flow meter positioned along the first stream line and upstream from the first switch.

10. A fluid delivery system, comprising:
a control valve for controlling the flow of the fluids from a bulk fluid source;
a flow meter positioned upstream from the control valve;
a first pressure transducer positioned upstream from the flow meter;
a second pressure transducer positioned in between the flow meter and the control valve; and
a switch positioned downstream from the control valve;
a first stream line coupled with the switch; and
a second stream line coupled with the switch, wherein the first stream line and the second stream line are positioned downstream from the switch.

11. The fluid delivery system of claim 10, further comprising: a third pressure transducer positioned between the control valve and the switch.

12. The fluid delivery system of claim 10, wherein the switch is a three way valve or two two-way valves.

13. The fluid delivery system of claim 10, wherein the flow meter is configured to monitor fluid flowing through the switch intermittently.

14. A system for chemical mechanical polishing of a substrate, comprising:
a platen assembly;
a polishing surface supported on the platen assembly;
one or more polishing heads on which substrates are retained while polishing; and
a fluid delivery system for delivering fluids to the polishing surface, comprising:
a bulk fluid source for supplying fluids;
a fluid delivery module for controlling and monitoring a ratio of fluids flowing from the bulk fluid source;
a first stream line positioned downstream from the fluid delivery module;
a first switch positioned along the first stream line;
a second stream line positioned downstream from the fluid delivery module; and
a second switch positioned along the second stream line, wherein the fluid delivery module splits the fluids into two streams flowing through the first stream line and the second stream line according to a pre-defined ratio.

15. The fluid delivery system of claim 14, wherein the fluid delivery module comprises:
a control valve for controlling the flow of fluids from the bulk fluid source;
a flow meter for monitoring the flow rate of the fluids flowing from the bulk fluid source; and
a first pressure transducer for monitoring the pressure of fluids flowing through the fluid delivery module.

16. The fluid delivery system of claim 14, wherein the fluid delivery module comprises:
a flow meter for monitoring the flow rate of the fluids flowing from the bulk fluid source;
a control valve positioned upstream from the flow meter;
a first pressure transducer positioned in between the control valve and the flow meter; and
a second pressure transducer positioned downstream from the flow meter.

17. The fluid delivery system of claim 14, wherein the fluid delivery module comprises:
a control valve for controlling the flow of fluids from the bulk fluid source;
a flow meter positioned upstream from the control valve;
a first pressure transducer positioned upstream from the flow meter; and
a second pressure transducer positioned in between the flow meter and the control valve.

18. The fluid delivery system of claim 17, wherein the fluid delivery module further comprises a third pressure transducer positioned downstream from the control valve.

19. The fluid delivery system of claim 17, further comprising:
a second control valve positioned along the first stream line and upstream from the first switch; and
a second flow meter positioned along the second stream line and upstream from the second switch.

20. A method for controlling the flow of a fluid through a fluid delivery system, comprising:
flowing a fluid through a fluid delivery system comprising:
a bulk fluid source;
a fluid delivery module for controlling and monitoring a ratio of fluids flowing from the bulk fluid source;
a first stream line positioned downstream from the fluid delivery module;
a first switch positioned along the first stream line;
a second stream line positioned downstream from the fluid delivery module; and
a second switch positioned along the second stream line, wherein the fluid delivery module splits the fluids from the bulk fluid source into two streams flowing through the first stream line and the second stream line according to a pre-defined ratio;
measuring a differential pressure for each of the first stream line and the second stream line by shutting off each of the first switch and the second switch intermittently; and
determining the ratio of the flows when both stream lines are open by comparing the differential pressure measurements from the first stream line and the second stream line.
